(19) United States
(12) Patent Application Publication
(10) Pub. No.: US 2018/0157526 A1
(43) Pub. Date: Jun. 7, 2018

(54) Method for Quasi-automatic Parallelization of Application Programs

(71) Applicants: Lin Gu, Hong Kong (HK); Zhiqiang Ma, Hong Kong (HK); Xinjie Yu, Shanghai (CN); Zhaohua Li, Hong Kong (HK)

(72) Inventors: Lin Gu, Hong Kong (HK); Zhiqiang Ma, Hong Kong (HK); Xinjie Yu, Shanghai (CN); Zhaohua Li, Hong Kong (HK)

(21) Appl. No.: 15/420,692

(22) Filed: Jan. 31, 2017

Related U.S. Application Data
(60) Provisional application No. 62/430,945, filed on Dec. 7, 2016.

(51) Int. Cl. G06F 9/48

(52) U.S. Cl. CPC G06F 9/4881

(57) ABSTRACT

A quasi-automatic method is provided to parallelize user programs with little or no changes in their original design, implementation or compiled binary code. The users issues a simple indication to inform a runtime system about the intent to run the programs in a parallel or distributed manner, and the runtime system executes a plurality of programs based on the original program to conduct the same computation with parallelization. The semantics of the original program is reused, and task instances are created based on the semantics and executed in parallel or distributedly. The method provides an easy yet reliable method for accelerating computation by distributing the original program processes on multiple computers. Through a semantics-aware I/O control and coordination, the runtime system improves the consistency between the logical result data generated by the parallel computation and the expected result data from the original program should it be executed on one computer.

### CROSS-REFERENCE TO RELATED PATENTS AND APPLICATIONS

This application claims the benefit of U.S. Provisional Application Ser. No. 62/430,945 filed on Dec. 7, 2016.

This application references the following patents.

U.S. Patent Documents

U.S. Pat. No. 8,949,786 B2 February 2015 Vaidya et al. 717/119

U.S. Pat. No. 8,949,809 B2 February 2015 Varma et al. 717/150

U.S. Pat. No. 9,003,383 B2 April 2015 Lavallee et al. 715/853

U.S. Pat. No. 9,348,560 B2 May 2016 Xie et al. G06F 8/34

U.S. Pat. No. 9,367,293 B2 June 2016 Halim et al. G06F 8/45

U.S. Pat. No. 9,495,223 B2 November 2016 Ebcioglu et al. G06F 9/52

### FIELD OF THE INVENTION

This invention is in the field of distributed computing and distributed systems, in particular parallel programming.

### BACKGROUND OF THE INVENTION

Distributed and parallel systems have been utilized in various fields to improve performance, throughput, robustness and scalability, and parallel computers and programs are therefore designed to conduct computation in parallel. To facilitate such computation, scientists and practitioners have developed parallel programming languages and algorithms, message passing or shared memory facilities, parallel compilers and parallel or distributed hardware systems.

However, it is still difficult to design and implement parallel programs, and a large body of programs are not designed to run in a parallel or distributed manner. When data or problem size get larger, programmers often needs to redesign and reimplement originally “sequential” programs to make them parallelized. Parallelizing a program necessitates decomposition of the original sequential logic flow into procedures that can be run relatively independently, and optimizing the communications among the procedures so that they do not introduce heavy overhead.

There are more intricacies in parallelizing a data analysis system, further to the essential work to parallelizing programs. A data analysis system usually consists of multiple phases using multiple programs with dependencies among them, and huge amounts of data communication between phases and processes. The management of computing resources also requires design effort for the parallelized system. These complexities of parallelizing an analysis pipeline make it more difficult to apply parallelism in real-world data analysis systems.

Automatic parallelization has been proposed to reduce the tedious and eror-prone work of manual parallelization. The general idea is to convert a sequential program to a parallel or distributed program, or a set of such program components. However, general program parallelization automation is impossible because program analysis for parallelization, one of the most important components of automatic parallelization, is incomputable. It is very complicated for an automatic parallelization algorithm to understand a sequential program, produce a parallelized version and guarantee they are equivalent.

A few prior work, as listed in the reference, explore automatic parallelization in specific contexts. They usually require that the original program is written in a high-level linguistic form with certain properties to assist program analysis, or tackle a specific program structure or map an algorithmic structure to a particular hardware system, such as a GPU array. Some programs, such as SQL programs, can run either sequentially or in parallel. But this kind of parallelization is not achieved by automatic parallelization, instead, both sequential and parallel versions of the programs code go through a re-compilation process, and either the sequential or parallel execution plan is chosen to conduct the computation. The same program, without recompilation is usually fixed in its parallelism.

### OBJECTS OF THE INVENTION

Embodiments of the presented invention relate to a method to parallelize data processing programs on a parallel or distributed system. By design, the new parallelization method requires only an indication from the user about the intent of running the program in parallel, and requires little or no algorithmic redesign, code restructuring and usually no recompilation, while the user may choose to provide options to fine-tune the parallel execution. Recognizing the intent, a runtime system launces multiple instances of the original program and performs semantics-aware coordination to generate useful logical view of the expected computational result. This method makes the parallelization procedure mostly automatic, and can work with many types of programs to generate useful and consistent computational results. We call this method quasi-automatic parallelization.

### SUMMARY OF THE INVENTION

A non-intrusive and quasi-automatic way of parallelization is presented, in order to reduce the difficulty of parallelizing programs, including the overhead in redesigning algorithms, handling communication among multiple processes and transforming the program code.

With this invention, users can run a program in parallel by indicating the intent to parallelize the computation, and a runtime system automatically launches multiple clones of the original program to conduct the computation in parallel and generates a view of the computational result such that it is useful or scientifically consistent with the result from the original “one-program” computation. The indication can take any form that the runtime system can receive and recognize so as to determine the intent. One example of such an indication is a simple token added as a prefix to a command running the original program. Without the token, the runtime system executes the program using one instance of the program, usually in the form of a process, in the system. When receiving or intercepting the token, the runtime system accelerates the computation automatically by running multiple clone instances from the original program on a plurality of processes and providing parallel execution support such as message passing among processes and shared data structure within the distributed system.

This invention generates a scientifically consistent view of the computational result by providing a semantic matching from the original program to a set of parallel or distributed program instances. By studying the semantics of the user program or the command, the invention decomposes the original computation into task components to parallelize the call. When a data analysis process is complex, the invention manages the process's workflow by creating, coordinating and controlling a plurality of tasks based on the original program to handle the computation. The substance of the final outputs is consistent with the results from running without the parallelism.

When the data processing involves multiple programs which form a processing “pipeline”, this invention may create pluralities of the tasks based on multiple types of original programs to process data in parallel with different processing logic.

Parallel or distributed programs are usually run on a cluster with a plurality of compute nodes each comprising a number of processors. This invention also provides coordination for the tasks among available resources to allocate appropriate amount of data or work to the processors.

### BRIEF DESCRIPTION OF THE DRAWINGS

For a more complete understanding of the invention, reference is made to the following description and accompanying drawings, in which:

FIG. 1 illustrates the execution of the original program on one computer system;

FIG. 2 illustrates the execution of multiple cloned program instances on multiple computers;

FIG. 3 illustrates one instance of the design of this invention, that a computer program is parallelized, and the task components are run on multiple nodes distributivly. The nodes form a cluster, and there are communication among them;

FIG. 4 illustrates a real world example of this invention that a user can parallelize a program by adding a simple token “glad” in the command; and

FIG. 5 illustrates a real world example of this invention that a bwa command for genome analysis can be parallelized by adding the token “glad” into the command.

### DESCRIPTION OF EMBODIMENTS

FIG. 1 shows the normal execution of an original program 1003 on one computer 1005. An actor 1001, which is a user or a higher level program, invokes the original program 1003 through an invocation interface, such as a command line interface or application programming interface (API). The original program 1003 reads input data 1002, processes the data, and generates result data 1004 as program output or side effects. The original program 1003 is an executable, a defined library module, or other program entities with clearly defined functionality and an invocation interface usually accessible by human users or script programming. Although some forms, such as a Python or shell program, naturally include source code, it is not required because recompilation is not a necessary step in this invention. An example of the original program is a binary executable invoked by a command line with its native options and arguments. The computer 1005 is usually one computer system with multiple tightly or loosely coupled processors. The original program 1003 is designed to run on such a single computer system, although it may employ traditional parallelization methods, such as multi-threading, MPI, OpenMP, and instruction-level parallelism to exploit the resources on the single computer system. Therefore, the performance of 1003 is limited by the computing resources on the single computer system 1005.

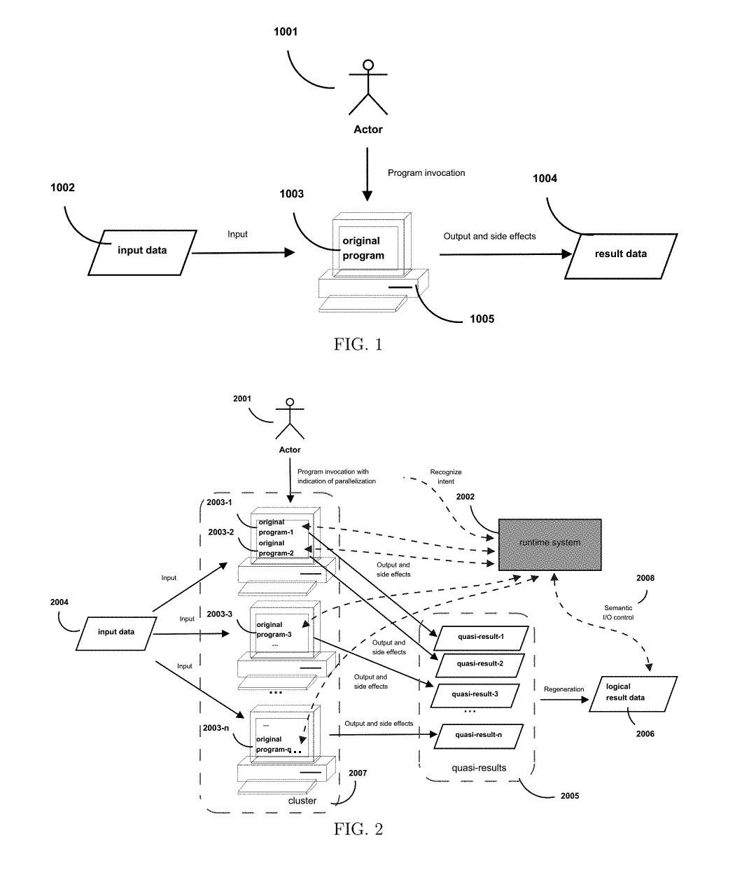

FIG. 2 shows the quasi-automatic parallelization of the original program on a cluster of multiple computers 2007. Without revising the algorithm or program structure, a quasi-automatic parallelization system launches n instances of the original program, original program-1 2003-1, original program-2 2003-2, . . . and original program-n 2003-n, where n can be an arbitrary integer number, to process the same input data 2004 and generate computational results. Each instance k-original program-k—is an equivalent clone of the original program. It is sometimes not necessary to do a bit-by-bit copy of the original program to obtain the equivalent clones—for example, the clones can take a form of executing the same program multiple times to form the same process or thread-executable images in the program space, which the operating system may further optimize to re-use one image for multiple instances. It is also possible that an actor may fine-tune the behavior of the clone instances by changing part of the code or execution context of the equivalent clones so that they are slightly different from each other or different from the original program, examples including adjusting program code, providing different options or arguments, and exercising additional optimization. However, the functionality of the original program and the clone instances of the original program should be the equivalent. For example, original program-k may accept an additional option to read and process a specific part of the input data, and employ some code to handle race conditions, but the processing logic and invocation method should be the same as those of the original program.

Each equivalent clone of the original program may process the entire input data or just part of them, and may generate results that are different from those produced by the original program's execution. We call such results quasi-results 2005. Based on the quasi-results, the quasi-automatic parallelization system regenerates logical result data 2006 to emulate the result data 1004 produced by the original program's execution on one computer. The logical result data 2006 is not necessarily identical to 1004, and it does not necessarily materialize as one piece of data. For many programs, it is possible to regenerate useful result data, or a view of useful data, from the quasi-results, and, in some cases, the result data 1004 and logical result data 2006 can be scientifically consistent.

Because the input data 2004 can be processed by either the original program or a plurality of equivalent instances of the original program, the system needs to be instructed which method to use. This is accomplished by the interaction of the actor 2001 and a runtime system 2002 in FIG. 2. The actor 2001 indicates the intent of conducting quasi-automatic parallelization for the original program, and the runtime system 2002 receives or intercepts the indication and recognizes the intent, then launches equivalent clones of the original program to process the input data 2004 if it is able to. If no such intent is recognized, the original program is executed without quasi-automatic parallelization. If such an intent is recognized but the runtime system 2002 is not able to conduct quasi-automatic parallelization, it is up to the system designer to decide how the system should behave in this situation. To indicate the intent, the actor 2001 may use a prefix command, a system flag, a message or any other computational constructs that the runtime system 2002 can receive or intercept to parse and recognize the intent. Although the original program runs on one computer, the runtime system 2002 may launch multiple equivalent clones of the original program on one computer in the cluster 2007, when the behavior of the original program permits such usage, in order to fully utilize system resources.

The runtime system 2002 in FIG. 2 performs several other important functions. First, it monitors the execution of original program-1 2003-1, original program-2 2003-2, . . . and original program-n 2003-n, and may help handle faults and failures. Second, the runtime system 2002 helps manage the quasi-results 2005 and controls the regeneration the logical result data 2006. The regeneration often requires a certain extent of understanding of the semantics of the original program as well as the result data. Hence, such management and control are called semantic I/O control 2008. As the name implies, semantic I/O control also extends to the input data, providing suitable data to individual clone instances with semantic awareness. In a complex data processing computation, the semantic I/O control coordinates the materialization and view formation of multiple result data from multiple computations when a number of original programs, some running in quasi-automatic parallelization and others not, are invoked, perhaps in multiple stages. Finally, the runtime system 2002 may also handle task management, data exchange and system bookkeeping functions so as to balance resource usage and facilitate concurrent tasks and jobs to execute in parallel.

FIG. 3 shows an exemplary situation when an original program is run with quasi-automatic parallelization on four nodes, each node being a computer. There is communication among the equivalent clones, which is facilitated by the runtime system, and the clone instances themselves may or may not have knowledge about the running on a parallel or distributed system. While FIG. 3 shows a situation that the user program is called on one of multiple nodes within the cluster, quasi-automatic parallelization can also be invoked by an actor outside the cluster, or take effect on a cluster with only one computer system. n some embodiments, this invention can be used to increase the utilization of the resources on a single computer system when the original program is not able to consume all computing resources on its own. For example, the original program is single-threaded, and a commodity computer may contain multiple processor cores. By launching multiple equivalent clones of the original program and conducting semantic I/O control to present logical result data, quasi-automatic parallelization provides a non-intrusive way to multiply the utilization of the resources on the computer instantly. With more computers in a cluster, more computing resources are included, and the performance of the original program is further scaled up while the program itself largely maintains a single-computer view and equivalent invocation method.

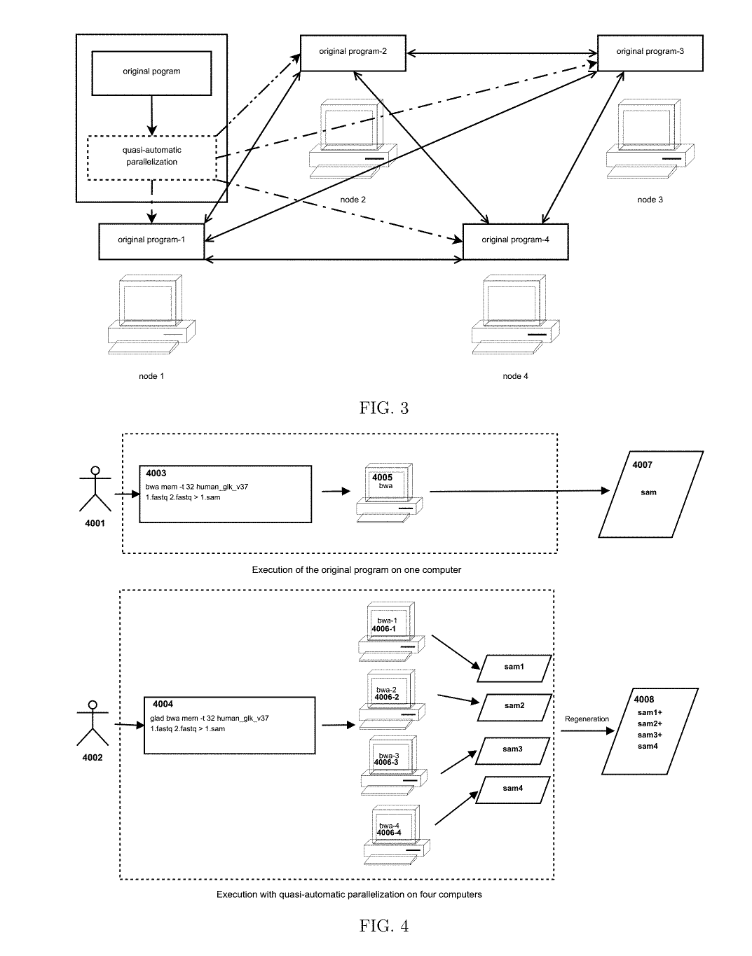

In some embodiments, a simple token is used to indicate the intent of parallelization. FIG. 4 described one real world example of the quasi-automatic parallelization. The original program is bwa, a genome data analysis program which aligns sequence reads or assembly contigs based on a reference genome. The input of this program can be as large as 400 GB, and thus running the program on a single computer for large input data can take long time. With this invention, the program can be accelerated with little effort. For an actor 4001, a user in this case, the only difference between running the original program on a single computer or running it on multiple computers with higher parallelism is just a token “glad” added before the original command line as a prefix command. In FIG. 4, for the execution of the original program on one computer, 4001 runs the bwa program with its options 4003 and arguments on the computer. The original program generates an output file in SAM file format 4007. For quasi-automatic parallelized execution, 4002 adds the token “glad” before the 4003 to create a new command 4004. When the runtime system observes 4004, it launches 4 instances of the bwa program, bwa-1 4006-1, bwa-2 4006-2, bwa-3 4006-3 and bwa-4 4006-4 on four computers. All the four bwa programs are, in this example, identical copies of the original program implementing the same processing algorithm, but the runtime system presents them with different parts of the input data with semantic I/O control. The programs are distributed to within the cluster as described in FIG. and FIG. 3. Therefore, four bwa programs run in parallel in the cluster, and increases the processing speed for nearly four times. After quasi-results are available, the runtime system performs semantic I/O control to regenerate the logical result data. The regeneration process, in this example, is simply concatenating the quasi-result files, sam1, sam2, sam3 and sam4 to generate a result file 4008. Following the semantics of the bwa program and SAM file format, we know that 4008 is scientifically consistent with 4007. It shall be noted that, in this design, the indication of the intent is not limited to a prefix command. In some embodiments, the indicator can be a program switch or any program constructs that the system can identify the intent of quasi-automatic parallelization. Similarly, the semantic I/O control can take many forms. For example, it is observed that some input pre-processing for the bwa program can help further improve the consistency of the logical result data.

This invention helps parallelize computation without invasive changes to the original program, such as algorithmic re-design, implementation change, enforced re-compilation and source code transformation. In most cases, the original program can be used as the equivalent clone directly without changes. A common adjustment is to provide additional or revised parameters to the equivalent clones so that they read and process different parts of the input data. It is also possible that the runtime system may perform various tuning and optimization when launching equivalent clones of the original program. Reusing the example of bwa in FIG. 4, we notice that adjustment of the program code to remove several race conditions can further improve the consistency after the aforementioned input pre-processing and make 4007 and 4008 100% consistent. In such case, it is conceivable that the equivalent clone employs such adjustments to adapt to the concurrent nature of the parallelized execution. Nevertheless, the data processing algorithm, the implementation details and the invocation method remain the same.

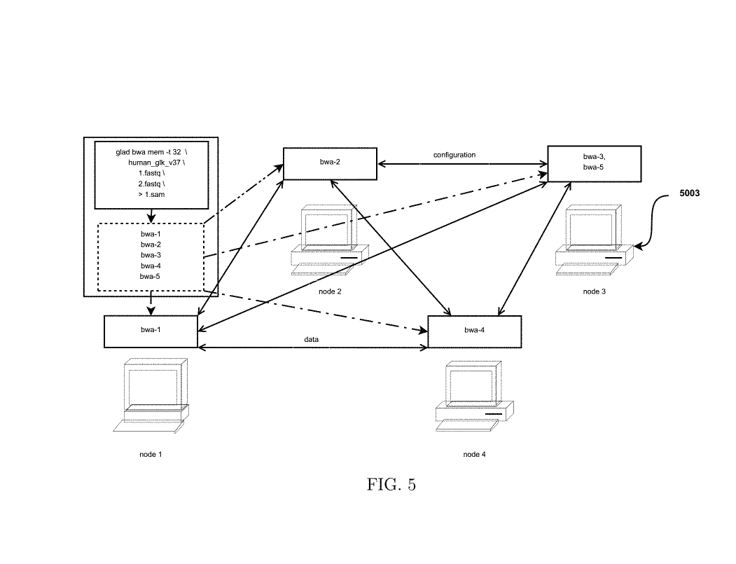

The quasi-automatic parallelization can work in combination with other types of single-system parallelization techniques, such as multithreading, and reuse the original program's existing implementation to realize such parallelization while distributing equivalent clones to a wider set of computer systems than the original program's inate parallelization method can handle. The runtime system plays a key part in this extension of parallelization scale—it coordinates intermedia data transferred among programs and manages the generation of the final logical result data through the semantic I/O control facility. FIG. 5 further illustrates the example based on FIG. 4 in a cluster view. An analysis task can be started by specifying one of the algorithm mem included in bwa, the number of threads 32, the genome reference database human_glk_v37, the input files 1.fastq and 2.fastq and the output file 1.sam. The computation can run with 32 concurrent threads, but it cannot be distributed on multiple computers in its original form. By adding the token “glad”, the actor indicates that she wants to run the computation with quasi-automatic parallelization, and the runtime system launches 5 equivalent clones of bwa on four computers. The resources are coordinated by the runtime system and the constituent computer nodes in the cluster can be assigned different numbers of equivalent clones of the original program according to the available resources. For example, 5003 from FIG. 5 is assigned 2 bwa clone instances. After the tasks finish, the runtime system may cooperate and combine the output files together to be 1.sam and make it visible to following processing programs.

The required level of semantics-awareness of a quasi-automatic parallelization may vary in different problems and systems. In some embodiments, there is little need to pre-process the input data and it is possible to combine the quasi-results to be logical result data by concatenation, with little or no knowledge on the semantics of the data. In some other embodiments, the designer may conduct sophisticated analysis on the quasi-results and perform complex transformation to produce the logical result data so that it satisfies the application requirement. We expect there can be a wide spectrum of semantic I/O control practices in various embodiments so that the system processes data and coordinates multiple tasks in a way that the generated results are useful to the applications.

It should be well understood that this invention can be applied in various kinds of situations, and the above embodiments of the inventions are simplified for illustration.

What is claimed is:

1. A quasi-automatic method to parallelize the execution of one or more programs in a non-intrusive way in the sense that no algorithmic redesign, recompilation or code transformation is necessarily required, comprising:
an actor indicating the intent to parallelize the execution of one or more original programs in a computation;
a runtime system recognizing the intent and, for each original program to be parallelized, launching multiple a plurality of equivalent clones of the original program to be run, usually, in a parallel or distributed manner on a cluster or one or more computers;
the plurality of equivalent clones of the original program processing input data and generating, as program output data or side effects, computational results called quasi-results; and
the runtime system employing knowledge on the semantics of the original programs and the result data to coordinate the regeneration of representation of the quasi-results to be logical output data.

2. The method of claim 1 further comprising that the syntax, semantics and invocation method of the original program are maintained without significant changes.

3. The method of claim 1, wherein the actor is a user or a higher-level program.

4. The method of claim 1, wherein the original program is designed to run one computer system, which may include multiple processors connected with a bus or interconnect, and may be able to use existing parallelism exploitation techniques, such as multithreading, to conduct a moderate-scale parallelization on one computer system and generate expected result data.

5. The method of claim 1, wherein the indication of the intent is a token, a program switch, a message or any other program-readable information the runtime system can receive and parse to recognize the intent.

6. The method of claim 1, wherein the programs, parallelized or not, may be correlated and form a processing pipeline where the result data of some programs may serve as input data of others.

7. The method of claim 1, wherein the runtime system launches equivalent clones of the original program, with or without adjustments, yet the functionality, algorithmic design and invocation method of the equivalent clones remain similar to those of the original program. Each instance of the equivalent clone of the original program accesses the input data or part of them, and produces a quasi-result.

8. The method of claim 1, wherein the runtime system conducts semantic I/O control to enhance the consistency between the expected result data from the execution of the original program on one computer and the logical result data from quasi-automatic parallel execution.

9. The method of claim 1, wherein the logical result data may materialize as real data in the same form as that of the expected result data or as a logical organization maintained by the runtime system to present a view of the result data in its logical entirety. In either form, the runtime system employ applicable measures to maximize the logical result data's consistency with the expected result data generated by the original program should it be run on one computer.

10. The method of claim 1, wherein the runtime system provides mechanisms to coordinated concurrent execution of a plurality of equivalent clones of the original program on the cluster, such as resource management, task communication, data exchange, dependency control and system bookkeeping.

11. The method of claim 7, wherein the equivalent clones of the original program can be produced as copies of the original program or logical instances of the original program, and the actor or the runtime system may adjust the equivalent clones' program or execution context to fine-tune their behavior in the system.

12. The method of claim 8, wherein the semantic I/O control manages or influences one or more of the following parts of the system: the organization of the input data, the instantiation of the equivalent clones of the original program, the management of quasi-results, the regeneration of the logical result data.
